(19) United States
(12) Patent Application Publication
(10) Pub. No.: US 2017/0122730 A1
(43) Pub. Date: May 4, 2017

(54) Methods and Apparatus to Project Distance Measurements and Images onto a Flat or Curved Surface

(71) Applicant: Daniel Roman Prochoda, Woodland Park, CO (US)

(72) Inventor: Daniel Roman Prochoda, Woodland Park, CO (US)

(21) Appl. No.: 14/931,874

(22) Filed: Nov. 4, 2015

(51) Int. Cl. G01C 3/08; G01B 11/25

(52) U.S. Cl. CPC G01C 3/08; G01B 11/25

(57) ABSTRACT

A non-contacting method and device to project scale or near to scale distance measurement markings onto a flat and/or curved surface. Additionally, the same method is used to adjust an image and/or the projection of an image onto a flat and/or curved surface, and additionally a device to project the image on a flat and/or curved surface is disclosed.

### CROSS-REFERENCE TO RELATED APPLICATIONS

Not Applicable

### BACKGROUND OF THE INVENTION

Technical Field

The present application relates to projecting distant measurement markings onto a flat or curved surface and to scaling projected images to account for distortion caused by surface orientation and/or surface contour.

Background

Visualizing distances on flat or curved surfaces typically involves placing a ruler, tape measure, and/or object of a known distance on the surface to establish length along the surface. This task is complicated by curvature of the surface, long distances that require the need to have an assistant hold one end of the measuring device, attempting to measure difficult to access locations, and/or the time it takes to move the device to measure multiple locations.

The current application proposes a non-contact method and distance marking device to project distance markings onto a flat or curved surface thus simplifying the process of measuring distances and/or increasing the safety of users by allowing users to project measurements onto difficult to reach surfaces from a safe location to obtain measurements. Additionally, the distance marking device provides a means for the measurement device to be moved to different locations while continually updating its measurement projections to maintain the desired scale.

The method and correction needed to project distance measurements onto a flat and/or curved surface utilizes the same method that is needed to create a mapping to correct projected images that are projected onto flat or curved surfaces that are distorted by the orientation of the projector to the surface, and by the contour of the surface. Therefore the method also provides a way for these projected images to be corrected.

Additionally a device for projecting an image onto a flat and/or curved surface is provided. This device makes it possible to possible to project images onto flat and/or curved surfaces without the stretching and compression that occurs when a projector is not perpendicular to a surface, and/or in which the surface contour distorts the image. The device can also be utilized to continually update its surface mapping, therefore providing a means for moving the projected images onto different surfaces while maintaining the same aspect ratio.

### BRIEF SUMMARY OF THE INVENTION

The present disclosure provides a method to project distance markings and/or a projected image onto a flat or curved surface while maintaining a desired scale. This is accomplished by creating a numerical, mathematical, and or angular projection representation of the surface so that the distance measurement markings and/or the image can be scaled to account for the distortion caused by surface orientation and/or contour.

Additionally, the disclosure provides a distance marking device that can be used to project distance measurement markings onto a flat or curved surface while maintaining the desired scale distances between measurement markings.

Finally, the disclosure provides a device that can be used to project an image onto a flat or curved surface while maintaining the desired scale by creating a numerical, mathematical, and/or angular projection mapping of how the image needs to be corrected in order to account for distortion caused by surface orientation and/or contour.

### BRIEF DESCRIPTION OF THE SEVERAL VIEWS OF THE DRAWINGS

For a fuller understanding of the nature and advantages of the present concepts, reference is made to the following detailed description of preferred and alternate embodiments, in which:

FIG. 1 illustrates an embodiment of the distance marking device;

FIG. 2 is used to illustrate the mathematical process that the non-contact method to project one or more distance markings and/or images that are to a desired scale or near to a desired scale onto a flat and/or curved surface might utilize to create a numerical, mathematical, and/or angular projection representation of a flat surface;

FIG. 3 is used to illustrate the mathematical process that the non-contact method to project one or more distance markings and/or images that are to a desired scale or near to a desired scale onto a flat and/or curved surface might utilize to create a numerical, mathematical, and/or angular projection representation of a curved surface;

FIG. 4 illustrates an embodiment of the distance marking device and/or the projection device which can be utilized to account for distance only;

FIG. 5 illustrates an embodiment of the distance marking device and/or the projection device which can be utilized to account for distance and orientation angle;

FIG. 6 illustrates an embodiment of the distance marking device and/or the projection device

FIG. 7 illustrates a potential arrangement of distance measuring element beams that strike a surface that might be utilized to capture surface orientation in three dimensions;

FIG. 8 illustrates an embodiment of the projection device which is projecting a non-corrected image onto a curved surface;

FIG. 9 illustrates an embodiment of the projection device which is projecting a corrected image onto a curved surface;

FIG. 10 illustrates an embodiment of the distance marking device and/or the projection device in which the distance measurement beams are being utilized correctly to measure distances to the surface, wherein the distance measurement beams are being utilized incorrectly to measure distance to the surface, and wherein an another embodiment of a distance marking device and/or the projection device is being utilized that is capable of dealing with a more difficult surface;

### DETAILED DESCRIPTION OF THE INVENTION

The above described methods and devices provide a means and devices for a user to project distance measurement markings and/or images onto a flat or curved surface while maintaining a desired scale of the distance markings and or the image. This accomplished by creating a numerical, mathematical, and/or angular projection description of the surface which can then be used to compensate for distortion caused by surface orientation with respect to the projection device, and/or surface contour.

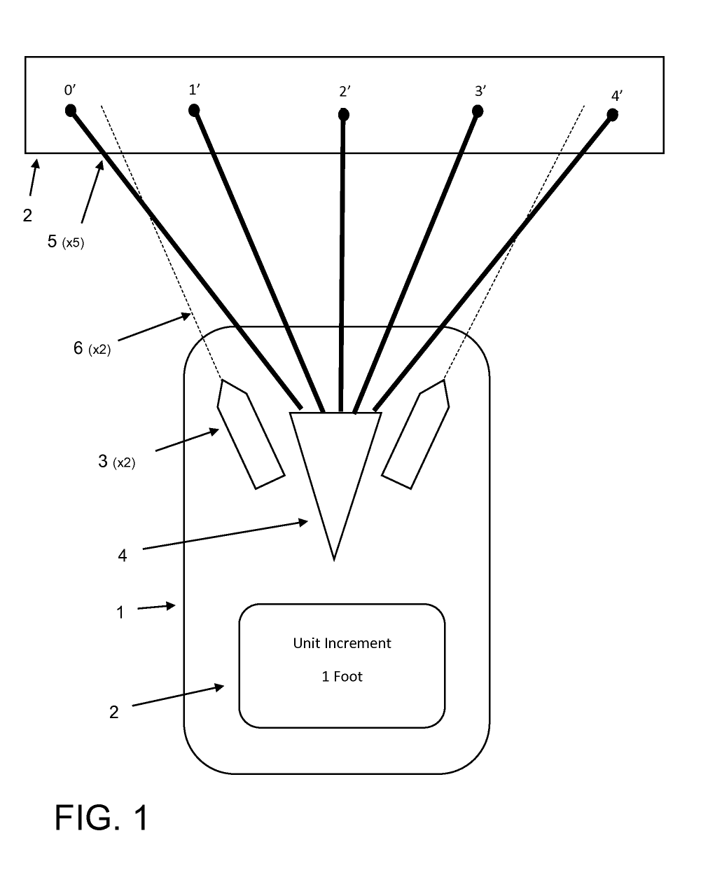

FIG. 1 depicts an embodiment of the distance marking device that will be utilized to present an introduction to the method and device concepts provided in this disclosure.

The distance marking device (1) is shown with two distance measuring devices (3) that are measuring the distance (6) to a flat surface (2). Once the distance measurements (6) have been obtained, the distance marking device (1) utilizes the distance measurements to compute a mathematical representation that numerically describes the surface, and/or utilizes mathematical expressions to describe the surface, and or directly calculates angular data that can be used by the projector (4) and/or internal processing system (not shown) to aim the distance markings beams (5) at their respective locations which are to scale when projected onto the surface. FIG. 1 shows an interface (2) which is a display that shows the desired measurement scale is 1 foot, which equates to the spacing of the distance marking beams (5).

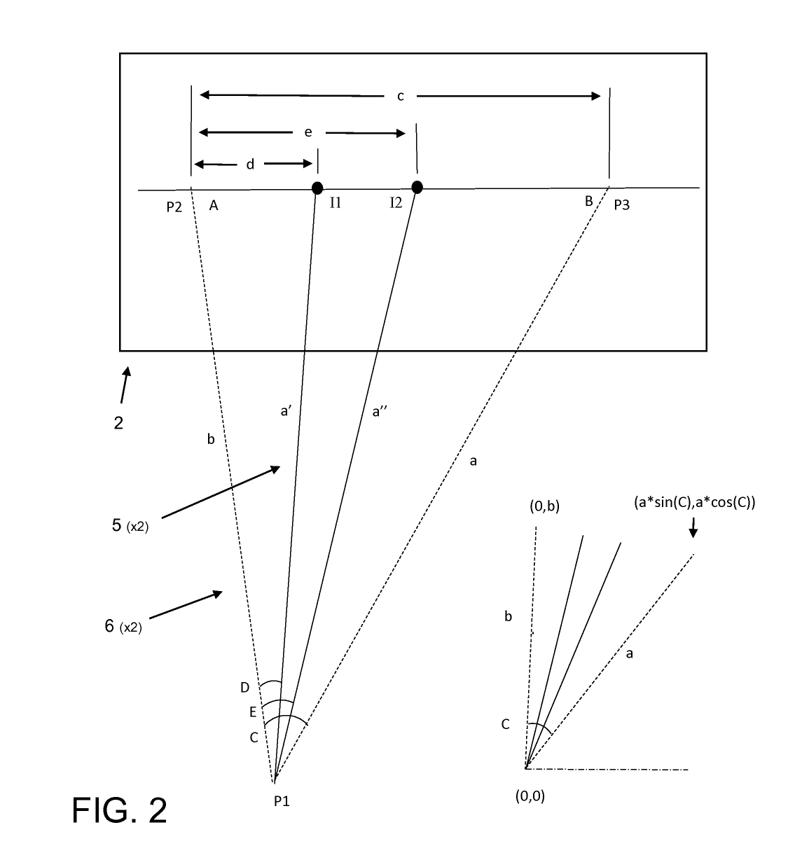

FIG. 2 is a diagram that depicts how the non-contact method to project one or more distance markings and/or images that are to a desired scale or near to a desired scale onto a flat and/or curved surface might create a mathematical representation of a flat surface. FIG. 2 illustrates two distance measuring beams (6) taking distance measurements to the flat surface (2) from P1 to P2, and from P1 to P3. A line is shown on the surface that includes both the points P2 and P3, however this line is present only to represent that the distance measurements should be taken as close as practical to this line to accurately reflect the surface orientation on which distance markings will be made. The angle between the two measurement beams C at P1 is known.

One method to determine the angle at which the projector should cast its first measurement beam utilizes trigonometry. In FIG. 2, referring to the larger image, distance of vectors are portrayed with small letters, while angles are portrayed with capital letters. With distance a and b, and angle C known, the distance c can be calculated using the Law of Cosines. Utilizing the Law of Sines, angle A can now be calculated. To calculate the position of the first projection which strikes the surface at position I1, the angle D needs to be determined as a reference point. If this method was being utilized for the distance marking device, a predetermined location from which to start the distance measurements may have already been established, wherein options might include the location on the surface which is perpendicular to the positioning of the distance marking device, and or one of the locations at which the distance marking device measures distance to the surface such as at P2 or P3. From this location, a known distance, possibly set by the user, would then be incremented for each measurement mark. If, however, the method was being utilized to calculate surface properties for an image projection device, than a set angle D and/or a known distance d might be utilized to determine where the first ray must strike the distance. In this example, we assume d is predetermined, in which case a new triangle is formed by P1, P2, and I1. With these two lengths and angle A known, distance a′ can now be solved using the Law of Cosines, and angle D can be determined using the Law of Sines. The process is then repeated to determine angle E, since the distance d is known, and the distance e has been determined like distance d. In this manner, the angles at P1 can be calculate to create numerous distance marking on the flat surface that follow a scaled length, and/or a mapping can be created and used that describes how the distance on the surface and/or angles at C change along the surface.

An additional method to create a numerical representation of the surface utilizes the smaller image of FIG. 2. The smaller image is a shrunken version of the larger image, however rotated slightly to the right. Using the same distance measurements a, b, and known angle C, a grid system can be determined to describe the surface. In this case, the out of surface location is given the coordinates (0,0), and the distance left distance measurement is given the coordinate (0,b), since b is the measurement distance. This process has created the first axis of a coordinate system. If the other coordinate axis is then created by representing a perpendicular axis that goes to the right from point (0,0), then we can use established trigonometric identities to determine the coordinates of the right measurements point at the surface. Utilizing trigonometric expressions and/or by developing an equation for a line between the two points that strike the surface, the coordinates of the two projected measurement marks can then be determined. Using distance formulas and or additional trigonometric expressions, a coordinate mapping can then be obtained for the length along the surface. With coordinates, projection angles and other data can also be determined if needed. Additionally, repeating the process at different locations on the surface can serve to establish a mapping of the surface that can be used for image correction.

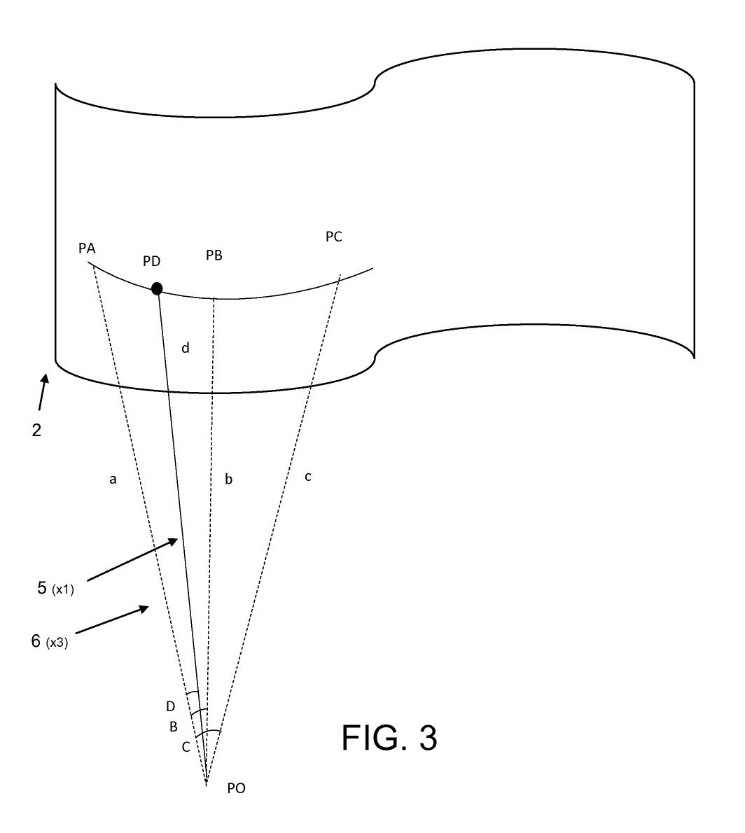

FIG. 3 illustrates an arc on a curved surface (2) for which it is desired to determine coordinates and/or locate out of surface angles that represent distances along the curved surface. One method to approach this problem is to create a coordinate system as was done for FIG. 2. In this case, the surface is not flat and therefore needs to be approximated with a Nth degree polynomial, where N is a whole number of one or higher. In this case, the surface appears to be curved in only one direction, and the curve in the area of measurements appears that it can be approximated with a second order polynomial. A second order polynomial can be generated to describe the curve if three coordinates can be obtained along the curve. Therefore, at least three distance measurements (6) need to be obtained to the surface. To create coordinates for these measurements, the same type of coordinate system is used as was illustrated in FIG. 2. This provides a means to obtain the coordinates for the three distance measurements. These coordinates are then used to generate a polynomial of the second degree that represents the surface contour. With this polynomial, and a known distance from PA to PD, coordinates for PD can be obtained by parameterizing the polynomial, creating an integration expression for determining distance along the polynomial, and numerically solving the polynomial for the desired distance to determine the coordinates of point PD. With PA, PD, and PB known, trigonometric expressions can now be derived to determine the off surface angle D to determine the direction of projection (5).

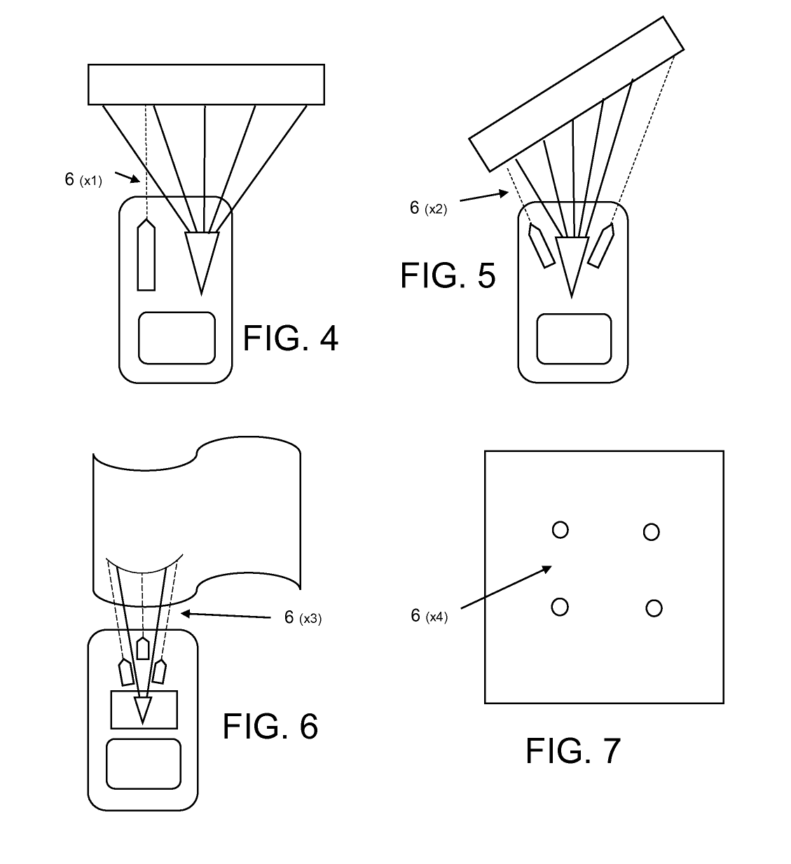

FIG. 4 illustrates an embodiment of a projection device and/ or distance marking device that utilizes only one distance measurement (6). This device would only account for distance from a flat surface, and would operate under the presumption that the projector is perpendicular to the surface.

FIG. 5 illustrates an embodiment of a projection device and/or distance marking device that utilizes two distance measuring elements (6). This device would be able to account for distance from a flat surface, and orientation to the surface.

FIG. 6 illustrates an embodiment of a projection device and/or distance marking device that utilizes three distance measuring elements (6). Although the three elements appear to be equally spaced in angle, this is not a necessary condition of the measurement apparatus. In this embodiment the device would be capable of accounting for distance and orientation to both flat and curved surfaces, and to also account for surface contours wherein the surface can be approximated with a second order polynomial.

FIG. 7 illustrates a potential pattern made by a projection device and/or distance marking devices having four distance measurement beams (6) striking the surface. The additional distance measurement beams would provide a means for the device to obtain orientation information of a flat surface that would account for not only side to side orientation differences, but orientation differences involving the orientation from top to bottom as well.

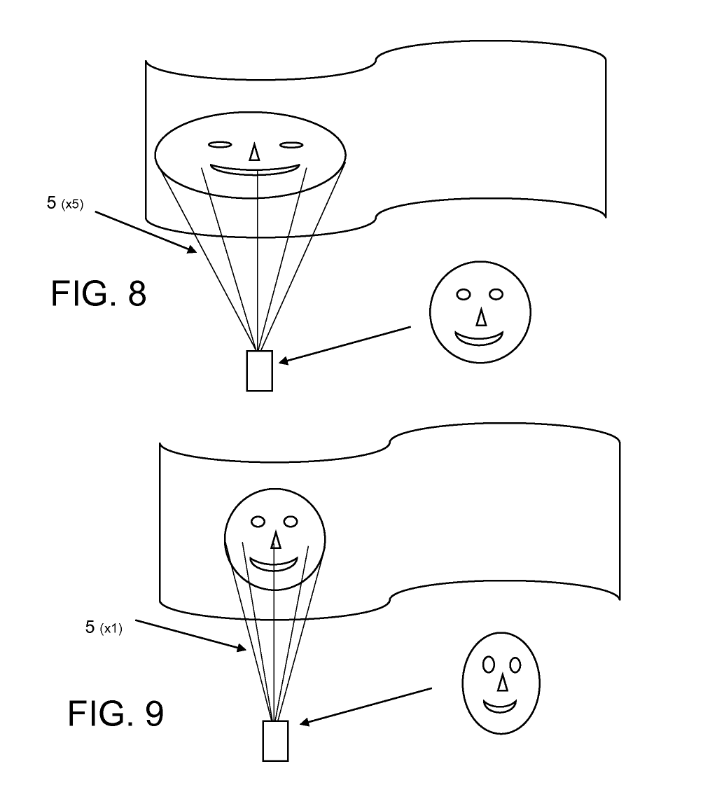

FIG. 8 depicts the potential distortion that might occur when a circular face is projected onto a curved surface. Note that the beams from the projection device (5) are roughly equally spaced in angle from the projector. FIG. 9 depicts the same situation as portrayed in FIG. 8, however the image has been altered to account for the surface curvature. This can be accomplished in one of two ways, by compressing the image very little in the middle, but more toward the edges, and/or by projecting the image by altering the direction at which some of the projection beams are projected. These alterations are symbolized by the compressed face that is projected, or by noting that the orientation of the projection beams (5) have changed to compress the projected image.

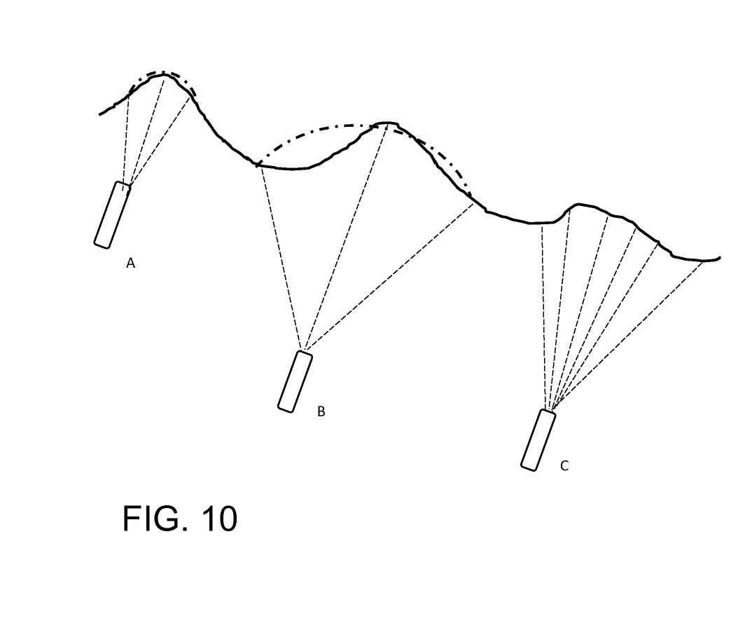

FIG. 10 illustrates in A how the non-contact method to project scale and/or near scale images could be used correctly to measure the surface curvature of a complex surface. B illustrates how the method could be used incorrectly, by attempting to measure the curvature of a complex curve using a device that is only capable of measuring the surface curvature of simple curves. C illustrates that if the user desired to measure the surface contour of a more complex surface that additional distance measurements would need to be obtained to accomplish this task.

Throughout this section, mention has been made of creating numerical, mathematical, and or angle projection representations of the surface, and that these representation can be utilized to change the method of projection and or alter the projected image. Current laser and coherent light projectors as well as software oriented image alteration products exist that are capable of adjusting projection parameters and/or utilizing distortion masks to alter images, and unless mentioned otherwise, these products and the various afforded protections of these products are intended to execute the desired processes to realize these corrections.

Distance measurements utilized in the methods and devices can be obtained via sonic, optical, and/or by utilizing laser distance measuring technologies. Laser is likely the preferable method due to its accuracy and ability to illuminate it target points. Additionally, depending on embodiment, one or more of the laser distance measuring elements may serve to create one or more distance measurement marks on the surface.

In addition to single beam distance measuring devices, measurements might also be obtained using laser scanning distance measuring technologies. Utilizing these technologies increases the resolution of the mathematical mappings of the surface by providing many more measurements to the surface, which would be beneficial for complex curved surfaces. The use of laser scanning technologies might also warrant straight line approximations for curved surfaces, in that a detailed mapping of the surface would serve to create a mesh much like that used in computation fluid technologies, were straight line approximations and such fine resolution would provide acceptable results for correcting projected images.

In addition to creating distance measurement markings by utilizing individual laser and or coherent light markings, another method to create markings on the surface might involve projecting an image onto surface that is scaled and contains designations of distance measurements. Another method would be for a processing system to alter the image pixels to create distance measurement images which might include colorful designs and/or animated characters that designate measurements by footprints and/or by other means.

Another method to portray distance measurements on the surface is by utilizing individual projection sources and/or projection sources that utilize a mechanical, computational, and/or electronic method to either alter the direction of markings, and/or by blanking the projection beams when not on target.

In addition to the non-contact method of projection, a distance marking device has also been disclosed. Various embodiments of such a device might be realized, where in the device might be a handheld device with distance measuring elements located at or near the projection device, thereby allowing a user to point and shoot to display distance measurements on difficult to access locations and/or to display distance measurements in a convenient manner. Additionally, the components may be separated where in one component projects the images while another obtains distance measurements. A processing system might be provided in whole or in part with the projection device, where in existing computer and/or mobile hardware with the addition of software might be utilized to serve this process.

Some embodiments may provide an interface that allows the user to change settings of the device and or choose options from various menus on a display. Options might include choosing distances, choosing location from which measurement markings begin, and/or possibly having the option to choose measurement scales that are projected in orthogonal directions.

Some embodiments might produce measurements repeatedly, so that as the direction at which the distance marking device is changed, the measurement scale adapts to its new surface location and contour.

Additionally, some embodiments might also include a camera, connections to the interface, and memory storage devices to provide a means to obtain measurements of different locations while saving the data and images that show where the data was obtained thereby greatly simplifying the task of obtaining measurements at off-site locations, and or to aid in communicating what measurement was obtained.

Additionally, some embodiments might include a fastener so that the distance marking device can be attached to other objects, such as overhead of a table where items are being cut, and/or against the side of a saw so that measurements can be taken while cutting.

A projection device is also proposed in which measurements are obtained to determine corrections needed to correct projection distortions caused by surface orientation and/or surface contour. As with the distance marking device, the ideal arrangement of distance measuring elements is near the area from which the images will be projected. A processing system might be provided in whole or in part with the projection device, where in existing computer and/or mobile hardware with the addition of software might be utilized to serve this process. Projection devices might include laser and/or other coherent light source projection systems. Alterations to images and/or projection direction and/or projection method might be performed by the processing system and/or by other means that utilize existing and or newly developed software and/or projection processors.

Some embodiments of the projector might also include an interface to provide a means to adjust settings and/or to control inputs and outputs to the projection device. Additionally, distance measurements might be obtained on a continuous basis, thereby allowing the projector to be in motion, and/or to have other objects in motion in front of the projector, wherein the image will continually adapt to new surface orientations and contour.

The present invention should not be considered limited to the embodiments described above, but rather should be understood to cover all aspects of the invention as fairly set out in the attached claims. Various modification as well as numerous structures to which the present invention may be applicable, will be readily apparent to those skilled in the art to which the present invention is directed upon review of the present disclosure. The claims are intended to cover such modifications.

What is claimed is:

1. A non-contact method to project one or more distance markings and/or images that are to a desired scale or near to a desired scale onto a flat and/or curved surface comprising:
Utilizing a non-contact distance measuring element and/or device, such as a laser range finder and/or laser scanner, obtain distance measurements from an off surface location preferably nearest to where the images and/or markings will be projected from, to the surface at which the image and/or markings will be projected to, wherein distance measurements are taken with known angles between distance measurements beams, and wherein the minimum number and orientation of distance measurements is dependent on surface orientation and contour;
Utilizing the distance measurements and the angles between measurements, create a numerical and or mathematical representation of the surface, and/or determine the angle or direction at which an image and/or marking needs to be projected in whole or in part in order to account for surface orientation and/or contour;
Utilize the numerical, mathematical, and/or angular data to alter the projected marking(s) and/or image(s) and/or to alter the manner and/or direction in which the marking(s) and/or image(s) are projected to account for the distortion caused by surface orientation and/or surface contour.

2. The non-contact method of claim 1, wherein a laser scanner is used to obtain the distance measurements.

3. The non-contact method of claim 1, wherein individual laser distance measuring elements are used to obtain the distance measurements.

4. The non-contact method of claim 1, wherein coherent light distance measuring elements, optical distance measuring elements, and/or sonic distance measuring elements are used to obtain the distance measurements.

5. The non-contact method of claim 1, wherein the numerical, mathematical, and/or angular data representations of the flat or curved surfaces are approximated with one or more straight line segments.

6. The non-contact method of claim 1, wherein the numerical, mathematical, and/or angular data representations of the flat or curved surfaces are approximated using mathematical functions.

7. The non-contact method of claim 1, wherein the projected images and/or markings are utilized exclusively for distance measurement;

8. The non-contact method of claim 1, wherein the projected images and/or markings are separately projected at desired distance intervals;

9. The non-contact method of claim 1, wherein the numerical, mathematical, and/or angular data representations of the flat or curved surfaces is utilized to process an image prior to it being projected onto a flat or curved surface;

10. The non-contact method of claim 1, wherein the numerical, mathematical, and/or angular data representations of the flat or curved surfaces is utilized to electronically, computationally, and/or mechanically alter the direction of a single or multiple projected laser beams and/or coherent light beams that constitute a part of and/or the entire projected image and/or marking;

11. The non-contact method of claim 1, wherein the non-contact method is utilized by a distance marking device that projects one or more distance markings that are to scale and/or near to scale on a flat and/or curved surface comprised of:
one or more laser range finding, coherent light finding, optical range finding, and or sonic range finding elements and/or devices situated so as to obtain one or more distance measurements to a flat and/or curved surface;
A processing system comprised of electronics, computer hardware and/or software that utilizes the non-contact method of claim 1, to convert the distance measurements into angles and/or directions at which a marking source must project its markings to account for desired scale, surface orientation, and/or surface contour,
one or more laser and/or coherent light marking sources and/or projection sources that can be electronically, computationally, and/or mechanically manipulated to project their mark at the determined angles and/or directions to create a projection that is dimensionally to the desired scale, and or near to desired scale on the surface.

12. The distance marking device of claim 11, further comprising an interface that provides a user a display and/or input controls for changing the state of the device, measurement units, location of where the distance measurements begin, providing options for additional distance measurement projections in other directions, providing menus and or indicators of options and or states of the system, and/or connectors for input and output.

13. The distance marking device of claim 11, wherein the distance measurements are obtained repeatedly so that the latest surface orientation and surface contour conditions can be utilized when adjusting the projected distance measurement markings.

14. The distance marking device of claim 11, further comprising a temporary and/or permanent fastener for a camera with optional connections to the interface and/or a memory storage device.

15. The distance marking device of claim 11, further comprising a fastener to fasten the device to other objects.

16. The non-contact method of claim 1, wherein the non-contact method is utilized by a projection device that projects one or more images that are to a desired scale and/or near to a desired scale on a flat and/or curved surface comprised of:
one or more laser range finding, coherent light finding, optical range finding, and or sonic range finding elements and/or devices situated so as to obtain one or more distance measurements to a flat and/or curved surface;
A processing system comprised of electronics, computer hardware and/or software that utilizes the non-contact method of claim 1, to convert the distance measurements into numerical, mathematical, and/or angular data that is then used to alter an image or its projection to account for the distortion caused by surface orientation and/or surface contour;
one or more laser and/or coherent light projection sources that projects the altered image so that its projection is dimensionally to the desired scale, and or near to the desired scale on the surface.

17. The projection device of claim 16, further comprising an interface that provides a user a display and/or input controls for changing the state of the device, projection scale, and providing menus and or indicators of options and or states of the system, and/or connectors for input and output.

18. The projection device of claim 16, wherein the distance measurements are obtained repeatedly thereby updating the projected image projection corrections continuously with the latest surface orientation and surface contour conditions.
